(19) United States
(12) Patent Application Publication
(10) Pub. No.: US 2007/0207245 A1
(43) Pub. Date: Sep. 6, 2007

(54) Method of creating perforations in a dough layer

(76) Inventor: Sail Katta Reddy, Urbana, IL (US)

Correspondence Address: SAIL KATTA REDDY, P.O. BOX 551, URBANA, IL, 61803, US

(21) Appl. No.: 11/330,960

(22) Filed: Mar. 2, 2006

(51) Int. Cl. A21D 6/00

(52) U.S. Cl. 426/503

(57) ABSTRACT

Manually lowering the entire perforator on a dough layer with the aid of handles such that the weight of the entire perforator pressuring the tips of the nail like objects to penetrate through the dough layer thus producing several fine perforations in 2-3 seconds. Place the users palm(s) on the two handles or on the entire perforator for additional pressure if necessary. Remove the perforator from the dough layer by simply lifting away the entire perforator manually. For additional perforations lift the perforator and change the position of the perforator a little and perforate the dough layer. If necessary, spray oil to the pins so that other substances may not stick to the pins.

### CROSS REFERENCE TO RELATED APPLICATIONS

A method of creating perforations in a dough layer is related to the apparatus in the application Ser. No. 09/955,671.

### STATEMENT REGARDING FEDERALLY SPONSORED RESEARCH AND DEVELOPMENT

Not applicable

### FIELD OF INVENTION

A method of this invention relates to a unique process of creating plurality of perforations in a dough layer.

### BACKGROUND OF THE INVENTION

There are very many methods of perforating a dough layer using different perforating tools available. For example, by using a dough docker hand tool available in the market involves a process of providing perforations where one has to use the tool more than once in order to provide enough perforations since the size of the tool is too small to provide even perforations in one attempt. Also needs user energy to use this method.

Thus, leading to repetitive stress syndrome to the user hand, and at times damaging the dough layer leading to high labor cost as well as food cost. U.S. Pat. No. 6,194,017 issued Feb. 27, 2001 to inventors Woodard, et al explains a method in providing perforations which involves holding and moving long handles and to repeatedly operate the handle may lead to repetitive stress syndrome to the user hands in the long run.

### SUMMARY OF PRESENT INVENTION

1. It is an object of the invention to provide a method of providing plurality of perforations in a dough layer involving very less manual labor possible.

2. It is the further object of my invention to provide several required perforations in a very less time possible.

3. It is the further object of my present invention that does not lead to too much of a repetitive stress syndrome.

### METHOD

A method of operation wherein by placing the entire perforator with the help of the two handles such that the nail like objects are pointing downwards in the direction of the gravity, the narrow and pointed ends of the nail like objects touching and penetrating through the dough layer without damaging the dough. The total weight of the entire perforator itself is sufficient to allow the nail like objects to penetrate through the dough layer. For additional assurance just place users palm(s) while applying pressure gently as necessary and lift the entire perforator with the help of two handles.

Experiments show that this additional pressure may not be necessary for perforation on certain dough layers.

Found out from the experiments that repetitive stress syndrome is likely to be very less since the process involves providing even perforations in one attempt.

Another method of operating the same perforator, where in the entire perforator is turned upside down such that the circularly shaped top portion is now the base of the entire perforator. The nail like objects will be protruding upwards in the direction opposite to the gravity. Use of a plate with or without fixed holes allowing nail like objects to provide perforations. Thus perforating the dough layer can be done by placing the plate containing the dough layer to be perforated and by pushing the plate downwards and lifting the plate with the dough layer upwards, by holding the sides of the plate as necessary and by lifting the plate up to remove the plate from the perforator. However, safety measures need to be taken while performing this method since nail like objects can be sharp and pointed in nature by keeping the fingers away from the pointed ends of the nail like objects while in operation.

While the invention has been described in connection with what is considered the most practical and preferred method, it is to be understood that the methods are not limited to the disclosed, but on the contrary is intended to cover various modifications, rearrangement of steps involved in the process of providing perforations.

1. A process of creating plurality of perforations in a dough layer using a hand tool for creating perforations, the process comprising:

2. Manually lowering the entire perforator on the dough layer with the aid of handles such that the weight of the entire perforator pressuring the pointed tips of the nail like objects to penetrate through the dough layer thus producing plurality of perforations in no time.
a) Placing the users palm on the perforator for additional pressure such that pressure is created for even perforations.
b) Removing the entire perforator from the dough layer is done by simply lifting away the entire perforator manually.

3. The method of claim 1, wherein step(a) includes placing the entire perforator on to the dough layer such that the plurality of nail like objects are in the same direction of the earths gravity.

4. Another process of perforating the dough layer using the same perforator comprising:
a) The entire perforator is turned upside down such that the circular shaped top portion is now the base of the entire perforator. The nail like objects will be protruding upwards in the direction opposite to the earth's gravity.
b) The method in claim 3, wherein perforating the dough layer by placing the plate containing the dough layer and by pushing the plate downwards and lifting the plate upwards after the perforations are created in the dough layer.
